(19) United States
(12) Patent Application Publication
(10) Pub. No.: US 2006/0050797 A1
(43) Pub. Date: Mar. 9, 2006

(54) Signal transmission structure

(75) Inventors: Shou-Kuo Hsu, Tu-Cheng (TW); Cheng-Hong Liu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/220,050

(22) Filed: Sep. 6, 2005

(30) Foreign Application Priority Data
Sep. 6, 2004 (CN) 200410051457.1

(51) Int. Cl. H04L 25/00

(52) U.S. Cl. 375/257

(57) ABSTRACT

A signal transmission structure includes a driving circuit block, a receiving circuit block, a main transmission line, and a radial patch. The main transmission line connects the driving circuit block to the receiving circuit block. The radial patch is formed between the driving circuit block and the main transmission line. The radial patch can reduce a switching rate when the signal state of the driving circuit changes rapidly. The radial patch serves as a compensation capacitor, to reduce a rate of switching of signals, and to reduce or even eliminate the problems of crosstalk and overshooting and undershooting of signals. It is of advantage that the radial patch is simple to manufacture and very suitable for mass production.

### BACKGROUND OF THE INVENTION

1. Field of the Invention

The present invention relates to techniques of transmitting electrical signals, and particularly to a signal transmission structure that can maintain signal integrity.

2. General Background

Mutual capacitance is the coupling of two electric fields, where electrical current proportional to the rate of change of voltage in a driver flows into a target line. The shorter the distance between two electrically conductive objects, the greater their mutual capacitance. Similarly, if two conductors are brought into close proximity with each other so that the magnetic field of one conductor interacts with the magnetic field of the other conductor, a voltage is generated in the second conductor as a result. This is called mutual inductance.

Crosstalk is the electrical “noise” caused by mutual inductance and mutual capacitance as between signal conductors, due to the close proximity of the signal conductors to each other. Crosstalk can cause digital system failure due to false signals appearing on a receiver.

In most circuits, a fast signal rise time is desirable. However, in some circuits, the fast signal rise time can cause reflections and/or EMI (electromagnetic interference) in the circuit, which can adversely affect the circuit's performance. EMI is caused by the rapid change in current as the signal changes between rise and fall states. Signal overshoot and undershoot are also undesired side effects of this rapid change in current.

FIG. 10 shows a conventional high speed signal transmission structure, and FIG. 11 shows an improved signal transmission structure conventionally configured to solve the above-described problems. Referring to FIGS. 10 and 11, a basic conventional signal transmission structure includes a driving circuit block 1, a first receiving circuit block 2, and a second receiving circuit block 3. A main transmission line 4 is connected to the driving circuit block 1, the first receiving circuit block 2 and the second receiving circuit block 3. The driving circuit block 1 includes a driving circuit 12 and a branch transmission line 14. The first receiving circuit block 2 includes a first receiving circuit 22, a branch transmission line 24, and a terminal capacitor 26. The second receiving circuit block 3 includes a second receiving circuit 32, a branch transmission line 34, and a terminal capacitor 36. The difference between the signal transmission structures of FIG. 10 and FIG. 11 is that in the structure of FIG. 11, a compensation capacitor 5 is connected to the driving circuit block 1, the first receiving circuit block 2 and the second receiving block 3 in order to mitigate the rate of switching of signals. Accordingly, in the structure of FIG. 11, when the driving circuit block 1 emits a 400 MHz, 1 V signal, a capacitance value of the compensation capacitor 5 is 4 pF. FIGS. 12 to 14 are graphs showing signal waveforms of the driving circuit 12, the first receiving circuit 22, and the second receiving circuit 32 in respect of the structure of FIG. 10. FIGS. 15 to 17 are graphs showing signal waveforms of the driving circuit 12, the first receiving circuit 22, and the second receiving circuit 32 in respect of the structure of FIG. 11. In FIGS. 12 to 14, numerals 110, 120, 130 denote signal waveforms of the driving circuit 12, the first receiving circuit 22, and the second receiving circuit 32 of the structure of FIG. 10. In FIGS. 15 to 17, numerals 210, 220, 230 denote signal waveforms of the driving circuit 12, the first receiving circuit 22, and the second receiving circuit 32 of the structure of FIG. 11. It can be seen that in the case of not having the compensation capacitor 5 (FIG. 10), the driving waveform is attenuated to very low levels due to signal reflection in transmission lines. However, in the case of having the compensation capacitor 5 (FIG. 11), the attenuation is reduced, and the rising time and the falling time are also reduced. Thereby, the switching rate is reduced.

However, employing the capacitor to depress the switching rate increases the cost of the signal transmission structure. What is needed, therefore, is a signal transmission structure which not only depresses the switching rate and maintains signal integrity, but also can be mass produced at a reasonable cost.

### SUMMARY

A signal transmission structure includes a driving circuit block, a receiving circuit block, a main transmission line, and a radial patch. The main transmission line connects the driving circuit block to the receiving circuit block. The radial patch is formed between the driving circuit block and the main transmission line. The radial patch can reduce a switching rate when the signal state of the driving circuit changes rapidly.

The radial patch serves as a compensation capacitor, to reduce a rate of switching of signals, and to reduce or even eliminate the problems of crosstalk and overshooting and undershooting of signals. It is of advantage that the radial patch is simple to manufacture and very suitable for mass production.

Other advantages and novel features will become more apparent from the following detailed description when taken in conjunction with the accompanying drawings, in which:

### BRIEF DESCRIPTION OF THE DRAWINGS

FIG. 1 is a circuit diagram of a signal transmission structure in accordance with a preferred embodiment of the preset invention;

FIG. 2 is an enlarged view of a radial patch and adjoining portions of the signal transmission structure of FIG. 1;

FIGS. 3 to 5 are graphs showing signal waveforms obtained using the signal transmission structure of FIG. 1;

FIG. 6 is a graph showing signal waveforms obtained for driving circuits of each of the signal transmission structures of FIGS. 1, 10 and 11;

FIG. 7 is a graph showing signal waveforms obtained for first receiving circuits of each of the signal transmission structures of FIGS. 1, 10 and 11;

FIG. 8 is a graph showing signal waveforms obtained for second receiving circuits of each of the signal transmission structures of FIGS. 1, 10 and 11;

FIG. 9 is a circuit diagram of a signal transmission structure having multiple receiving circuits, according to another embodiment of the present invention;

FIG. 10 is a circuit diagram of a conventional signal transmission structure;

FIG. 11 is a circuit diagram of another conventional signal transmission structure;

FIGS. 12 to 14 are graphs showing signal waveforms obtained using the signal transmission structure of FIG. 10; and

FIGS. 15 to 17 are graphs showing signal waveforms obtained using the signal transmission structure of FIG. 11.

### DETAILED DESCRIPTION OF THE EMBODIMENTS

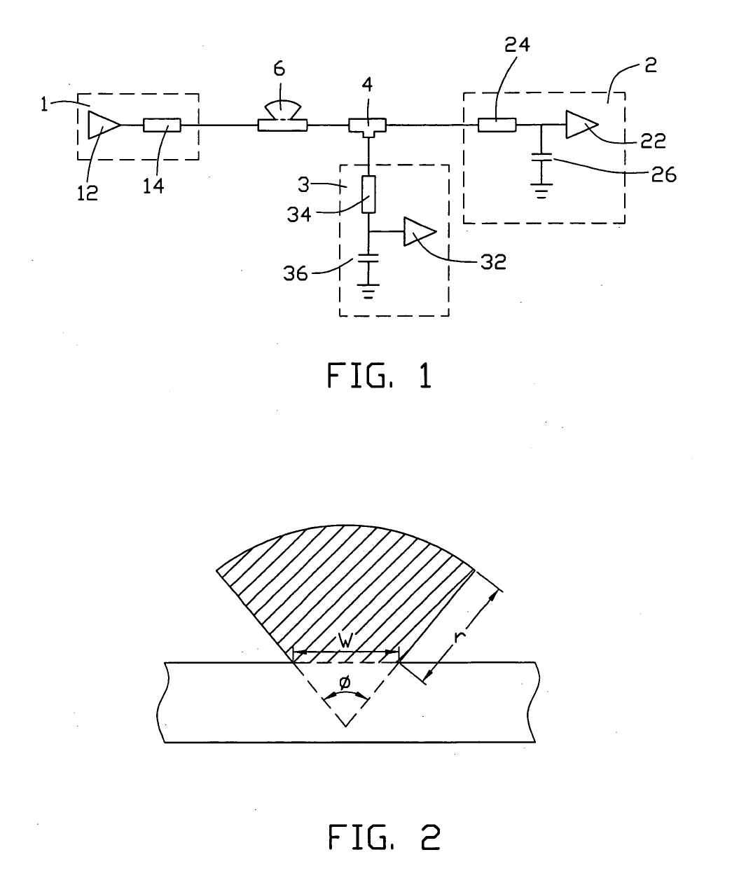

Referring to FIG. 1, a signal transmission structure in accordance with a preferred embodiment of the present invention includes a driving circuit block 1, a first receiving circuit block 2, and a second receiving circuit block 3. A main transmission line 4 connects to the driving circuit block 1, the first receiving circuit block 2 and the second receiving circuit block 3. The driving circuit block 1 includes a driving circuit 12 and a branch transmission line 14. The first receiving circuit block 2 includes a first receiving circuit 22, a branch transmission line 24, and a terminal capacitor 26. The second receiving circuit block 3 includes a second receiving circuit 32, a branch transmission line 34, and a terminal capacitor 36. The main transmission line 4 serves a main transmission function, and the branch transmission lines 14, 24, 34 serve signal transmission functions within each circuit block 1, 2, 3 respectively. A radial patch 6 connects to the driving circuit block 1, the first receiving circuit block 2, and the second receiving circuit block 3. The radial patch 6 is generally fan-shaped, and has a capacitor characteristic. The radial patch 6 is manufactured by copper patched on a printed circuit board (PCB) in a metal-etched process of making the PCB. Making the radial patch 6 essentially does not require extra costs, and is thus very suitable for mass production.

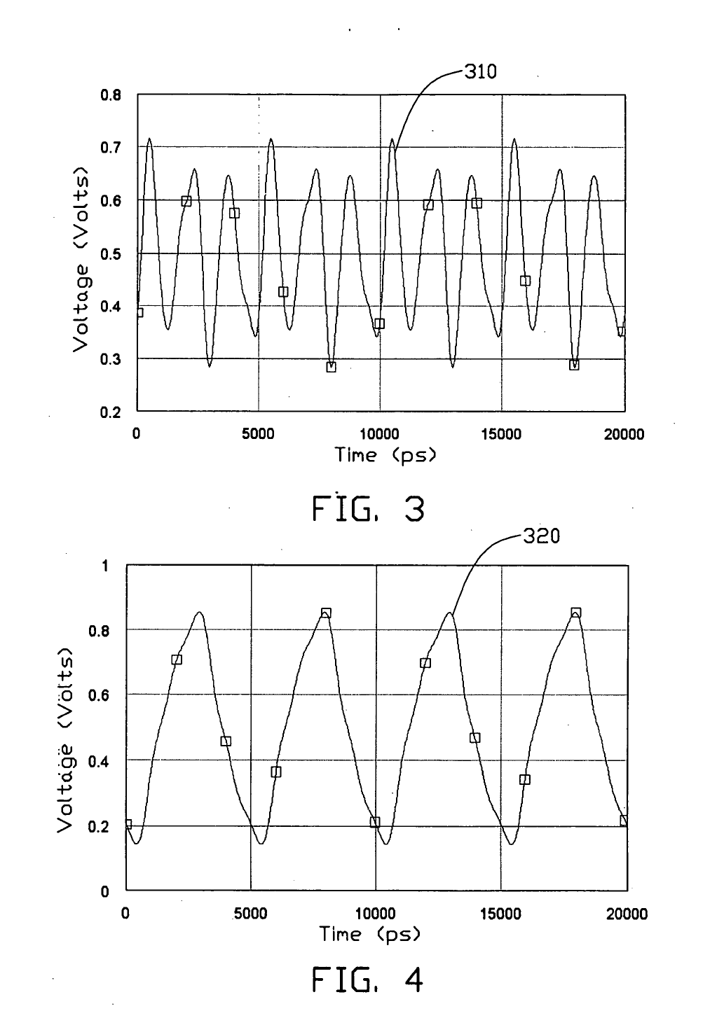

FIG. 2 is a magnified view of the radial patch 6, which is shown as a hatched area. Φ denotes the center angle of a sector defined by the radial patch 6, and r denotes a portion of the radius of the sector which forms each of two opposite boundaries of the radial patch 6. W denotes the length of a third boundary of the radial patch 6 which interconnects said two opposite boundaries. The third boundary subtends the center angle Φ of the sector. The capacitance of the radial patch 6 can be approximately estimated as follows:

$$C = {ɛ}_{r} {ɛ}_{o} \frac{A}{d} ; \qquad ( 1 )$$

wherein C denotes the capacitance of the radial patch 6, εᵣ denotes the relative dielectric coefficient of the PCB, εₒ denotes the absolute dielectric coefficient of the PCB, A denotes an area of the radial patch 6, and d denotes a thickness of a dielectric layer of the PCB.

A triangular portion of the sector includes one side that is the third boundary of the radial patch 6. This triangular portion is not part of the radial patch 6. Thus the area of the triangular portion subtracted from the area of the sector is the area of the radial patch 6. In the following formula, A1 denotes the area of the sector, and A2 denotes the area of the triangular portion. Accordingly, A=A1−A2. In this embodiment, εᵣ=4.0, εₒ=8.854, Φ=60°, r=4.4 mm, and W=0.36 mm. Thus A1 and A2 are expressed by the following formulas (2) and (3):

$$\begin{matrix}A1 = \frac{60 °}{360 °} \cdot π \cdot {( r + W )}^{2} & ( 2 ) \\ A2 = \frac{1}{2} {W}^{2} sin 60 ° & ( 3 )\end{matrix}$$

Taking all terms and formulas (2) and (3), and applying them to formula (1), the following equation can be derived:

$$\begin{matrix}C = {ɛ}_{r} {ɛ}_{o} \frac{A}{d} \\ = {ɛ}_{r} {ɛ}_{o} \frac{A1 - A2}{d} \\ = {ɛ}_{r} {ɛ}_{o} \frac{\frac{60 °}{360 °} \cdot π \cdot {( r + W )}^{2} - \frac{1}{2} {W}^{2} sin 60 °}{d} \\ = 4.0 \cdot 8.854 \cdot {10}^{- 15} \frac{\frac{60 °}{360 °} \cdot π \cdot {( 4.4 + 0.36 )}^{2} - \frac{\sqrt{3}}{4} {( 0.36 )}^{2}}{0.102} \\ = 4.1 pF\end{matrix}$$

$$wherein , \\ A1 = \frac{60 °}{360 °} \cdot π \cdot {( r + W )}^{2} = \frac{60 °}{360 °} \cdot π \cdot {( 4.4 + 0.36 )}^{2} \approx 12 ( {mm}^{2} )$$

It can be seen that to produce a 4 pF capacitance, the area of the radial patch 6 should preferably be at least 12 mm² in the PCB. The capacitance of the radial patch 6 and the area of the radial patch 6 are directly proportional to each other.

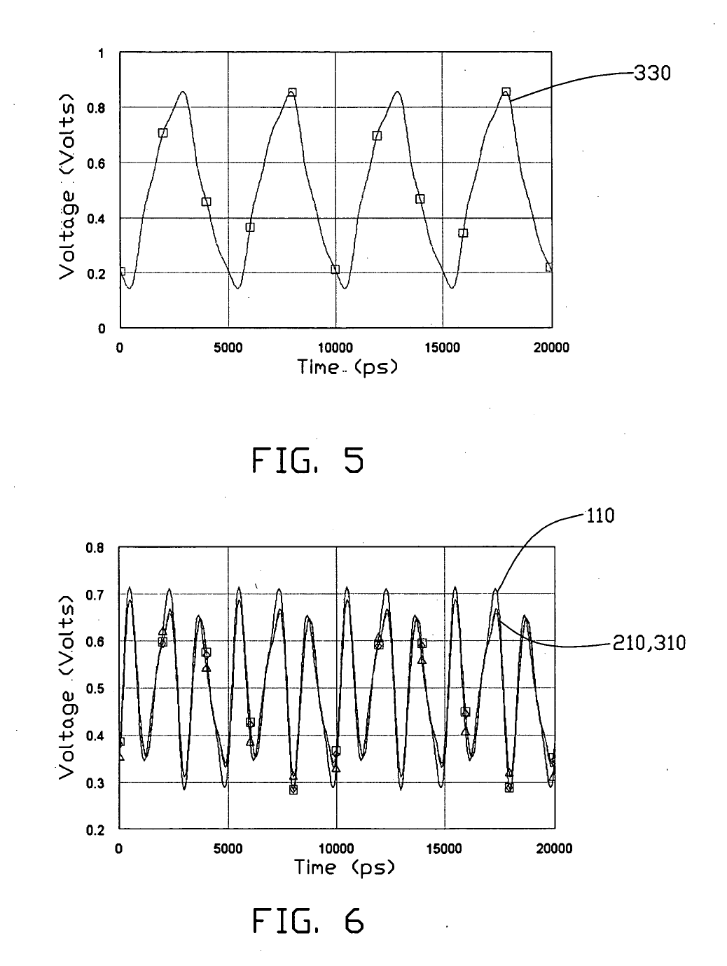

Referring to FIG. 1, it is assumed that the capacitance value of the radial patch 6 is 4 pF. Further, for the purposes of obtaining data on simulated performance of the signal transmission structure, it is assumed that the driving circuit block 12 emits a 400 MHz, 1V signal. The first receiving circuit 22, the second receiving circuit 32, the main transmission line 4, and the branch transmission lines 14, 24, 34 are similar components as shown in the signal transmission structure of FIG. 11 (related art), both in terms of individual structure and in terms of mechanical and electrical interrelationships. FIGS. 3 to 5 are graphs respectively showing signal waveforms of the driving circuit 12, the first receiving circuit 22, and the second receiving circuit 32 of the signal transmission structure of the preferred embodiment of the present invention. In FIGS. 3 to 5, numerals 310, 320, 330 denote signal waveforms of the driving circuit 12, the first receiving circuit 22, and the second receiving circuit 32.

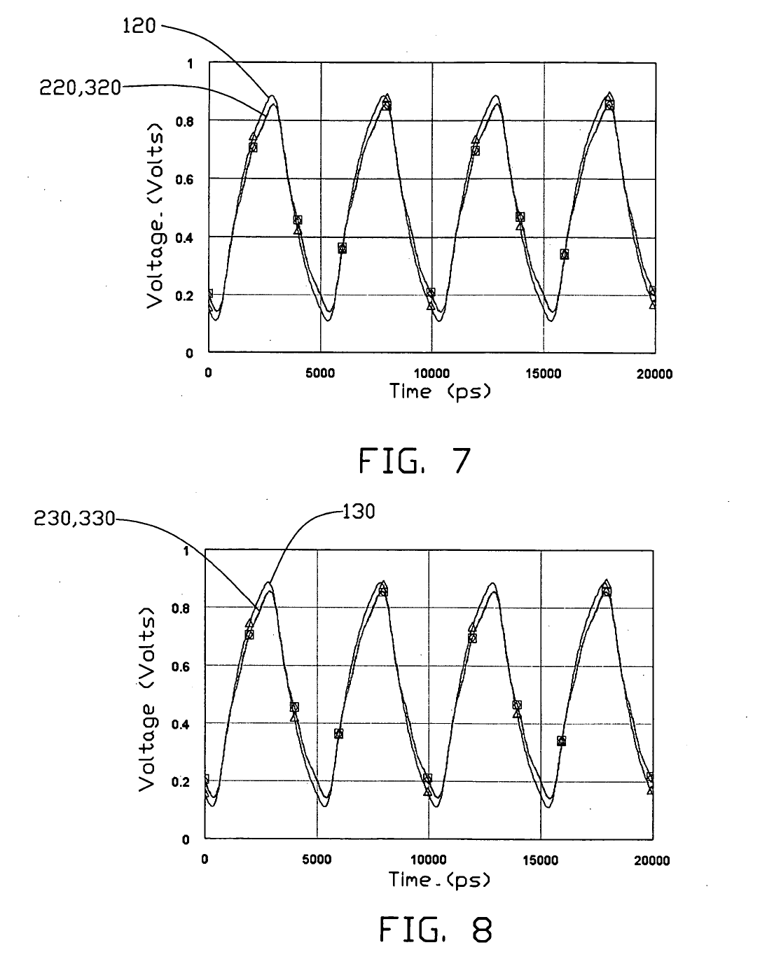

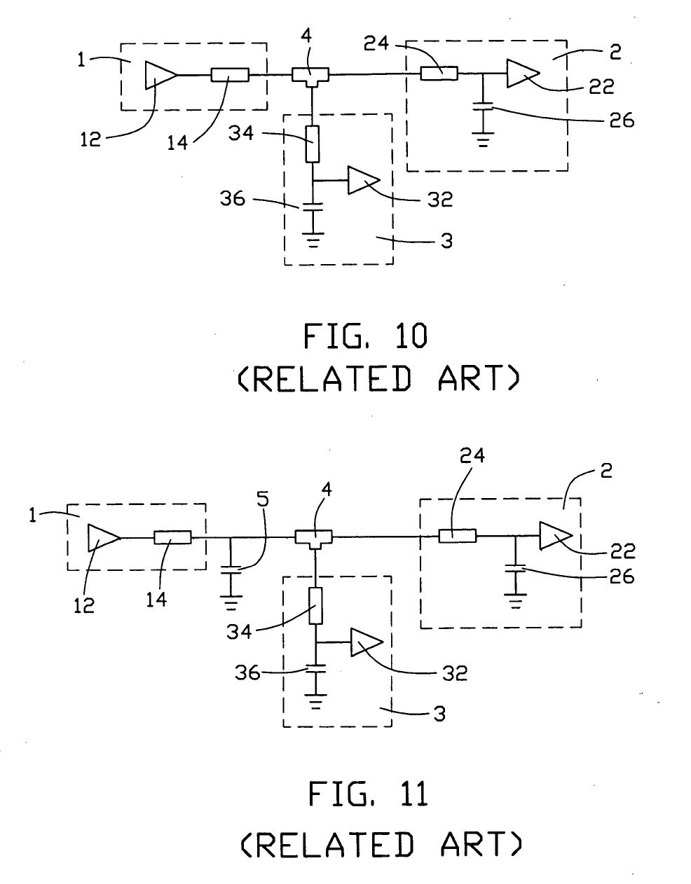

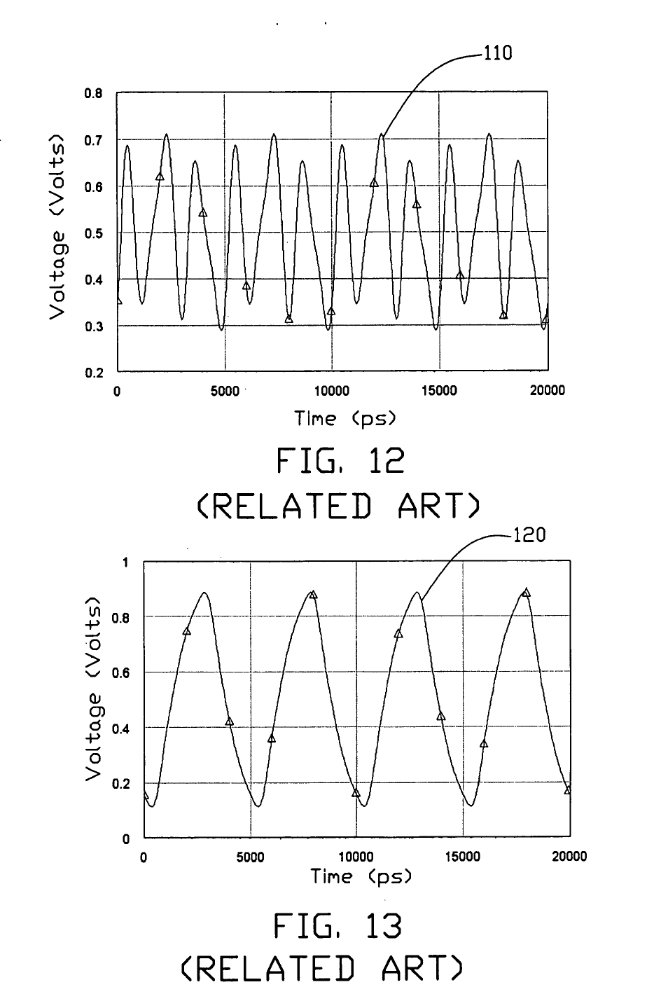

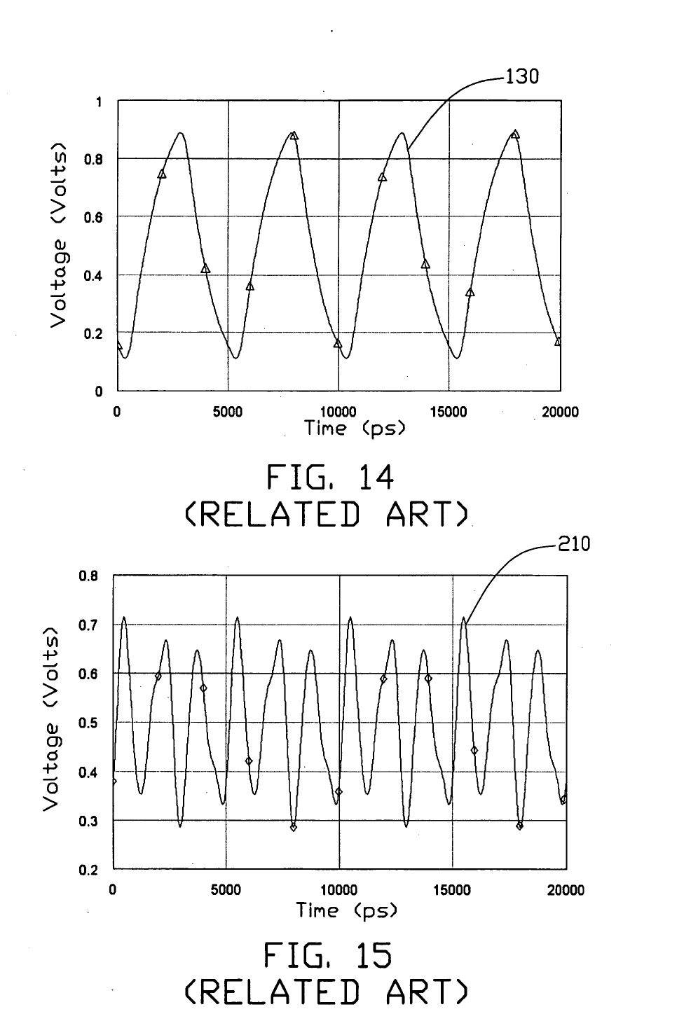

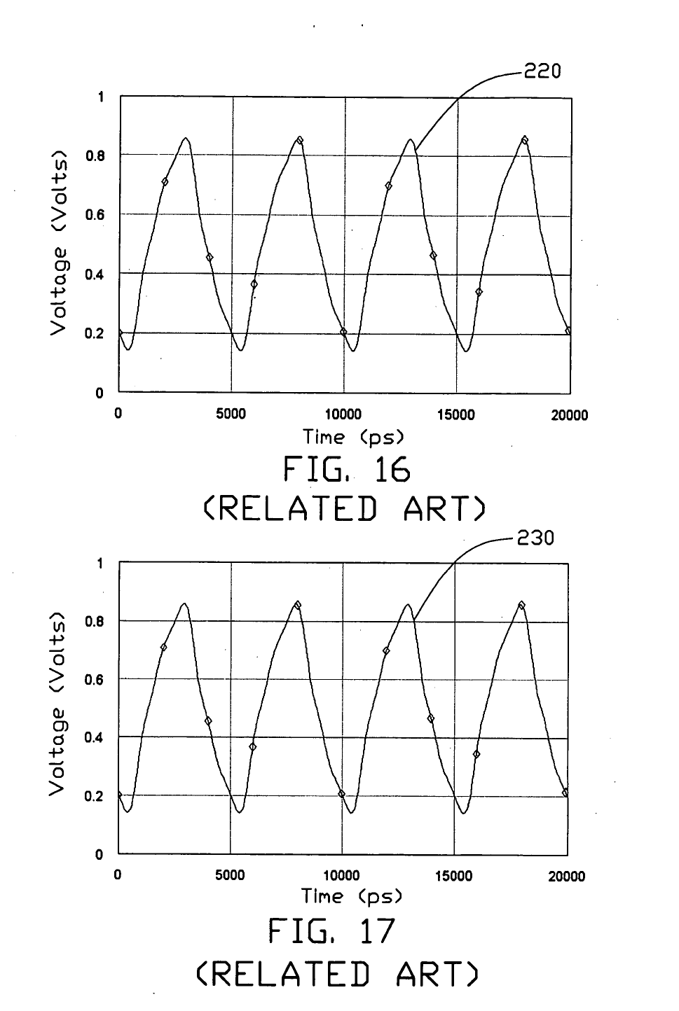

FIGS. 6 to 8 are comparative graphs showing waveforms in respect of the following three signal transmission structures: (a) there is no matching circuit connected among the driving circuit block 1, the first receiving circuit block 2, and the second receiving circuit block 3, as shown in FIG. 10 (related art); (b) the compensation capacitor 5 as a matching circuit is coupled to the driving circuit block 1, the first receiving circuit block 2 and the second receiving block 3, as shown in FIG. 11 (related art); and (c) the radial patch 6 as a matching circuit is connected between the driving circuit block 1 and the first receiving circuit block 2 and the second receiving block 3, as shown in FIG. 1 (preferred embodiment of the present invention). Numerals 110, 120, 130 denote signal waveforms of the driving circuit 12, the first receiving circuit 22, and the second receiving circuit 32 for structure (a). Numerals 210, 220, 230 denote signal waveforms of the driving circuit 12, the first receiving circuit 22, and the second receiving circuit 32 for structure (b). Numerals 310, 320, 330 denote signal waveforms of the driving circuit 12, the first receiving circuit 22, and the second receiving circuit 32 for structure (c). As shown in FIGS. 6 to 8, the waveforms of the driving circuit 12, the first receiving circuit 22, and the second receiving circuit 32 are nearly superposed upon each other for structures (b) and (c). However, for structure (c), the radial patch 6 may mitigate the rising time and falling time of the signal to reduce the switching rate of a signal.

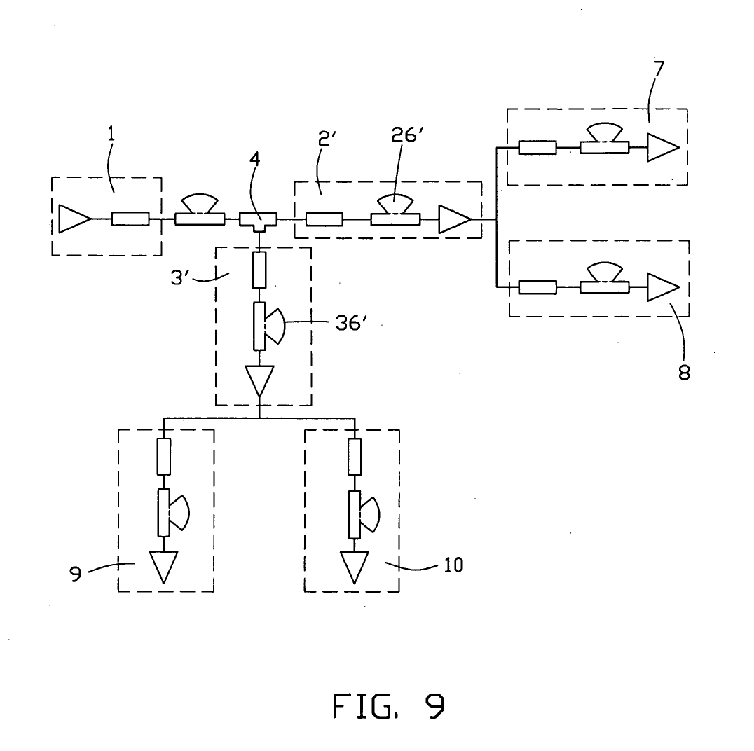

In the above-described signal transmission structure of the preferred embodiment of the present invention, each circuit block 1, 2, 3 has only one driving circuit or receiving circuit. However, according to the present invention, a receiving circuit block can include at least one receiving circuit. Further, in general and as described above, a radial patch 6 can replace a conventional compensation capacitor 5 to reduce the switching rate of a signal. Referring to FIG. 9, this shows a signal transmission structure having multiple receiving circuits (i.e., a “multi transmission structure”), according to another embodiment of the present invention. In the multi transmission structure, a first circuit block 2′ further connects to receiving circuit blocks 7 and 8, and a second circuit block 3′ further connects to receiving circuit blocks 9 and 10. In this configuration, each of the circuit blocks 2′ and 3′ can be a driving and/or receiving circuit block. Instead of having the capacitors 26 and 36 of the signal transmission structure of the preferred embodiment, the circuit blocks 2′, 3′ of the multi transmission structure may have radial patches 26′ and 36′ respectively.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A signal transmission structure comprising:
a driving circuit block;
a receiving circuit block;
a main transmission line connecting the driving circuit block to the receiving circuit block; and
a radial patch provided between the driving circuit block and the main transmission line, for reducing a switching rate of a signal.

2. The signal transmission structure as claimed in claim 1, wherein the driving circuit block comprises a driving circuit and a first branch transmission line, and the first branch transmission line transmits the signal from the driving circuit to the main transmission line.

3. The signal transmission structure as claimed in claim 2, wherein the receiving circuit block comprises a receiving circuit and a second branch transmission line, and the second branch transmission line transmits and receives signals between the main transmission line and the receiving circuit.

4. The signal transmission structure as claimed in claim 2, wherein the receiving circuit block comprises a receiving circuit, a compensation capacitor, and a second branch transmission line, the second branch transmission line transmits and receives signals between the main transmission line and the receiving circuit, and the compensation capacitor is connected between receiving circuit and the second branch transmission line to reduce a signal switching rate.

5. The signal transmission structure as claimed in claim 1, wherein the radial patch is manufactured by copper patched on a printed circuit board (PCB).

6. The signal transmission structure as claimed in claim 5, wherein the radial patch is generally fan-shaped.

7. The signal transmission structure as claimed in claim 6, wherein a capacitance of the radial patch and an area of the radial patch are directly proportional to each other.

8. The signal transmission structure as claimed in claim 7, wherein when the capacitance of the radial patch is 4 pF, the area of the radial patch is at least 12 mm².

9. A signal transmission structure comprising:
a driving circuit block, the driving circuit block comprising a driving circuit and a first branch transmission line coupled to the driving circuit;
at least one receiving circuit block, the receiving circuit block comprising a receiving circuit and a second branch transmission line coupled to the receiving circuit;
a main transmission line coupling to the second transmission line; and
a radial patch connecting the first branch transmission line and the main transmission line, for reducing a switching rate of a signal of the driving circuit.

10. The signal transmission structure as claimed in claim 9, wherein the receiving circuit block comprises a compensation capacitor connected between the receiving circuit and the second branch transmission line, to reduce a signal switching rate.

11. The signal transmission structure as claimed in claim 9, wherein the receiving circuit block comprises a radial patch connected between the receiving circuit and the second branch transmission line, to reduce a signal switching rate.

12. The signal transmission structure as claimed in claim 9, wherein the radial patch is manufactured by copper patched on a printed circuit board (PCB).

13. The signal transmission structure as claimed in claim 12, wherein the radial patch is generally fan-shaped.

14. The signal transmission structure as claimed in claim 13, wherein a capacitance of the radial patch and an area of the radial patch are directly proportional to each other.

15. A method to establish capacitance ability of a circuit on a circuit board for signal transmission, comprising the steps of:
attaching a transmission line of a circuit on a circuit board for signal transmission, said transmission line having at least two electrically connective ends;
electrically connecting a driving circuit with one of said at least two ends of said transmission line, and connecting at least one receiving circuit with respectively another of said at least two ends of said transmission line so as to perform said signal transmission between said driving and receiving circuits along said transmission line; and
forming an electrically conductive patch integrally extending along said circuit board and away from a portion of said transmission line located between said one of said at least two ends of said transmission line and said another of said at least two ends of said transmission line so as to perform capacitance ability of said circuit by said patch.

16. The method as claimed in claim 15, wherein said patch is a redial patch formed in a sector shape.

17. The method as claimed in claim 15, wherein said transmission line and said patch are made by a metal-etched process of making said circuit on said circuit board.
